(19) United States
(12) Patent Application Publication
(10) Pub. No.: US 2026/0077516 A1
(43) Pub. Date: Mar. 19, 2026

(54) TELESCOPIC CUTTER

(71) Applicant: Dongguan Beibing Technology Co., Ltd., Dongguan (CN)

(72) Inventor: Meifang Chen, Dongguan City (CN)

(73) Assignee: Dongguan Beibing Technology Co., Ltd., Dongguan (CN)

(21) Appl. No.: 19/290,174

(22) Filed: Aug. 4, 2025

(30) Foreign Application Priority Data
Sep. 18, 2024 (CN) 202411306748.4

(51) Int. Cl. B26B 5/00

(52) U.S. Cl. CPC B26B 5/003

(57) ABSTRACT

The present disclosure relates to a telescopic cutter, including a cutter holder, a cutter body, and a connecting rod assembly. The cutter holder is provided with an accommodating cavity with an opening at one end, a sliding rail is arranged inside the accommodating cavity, and the sliding rail has a central travel position. The cutter body is movably arranged on the sliding rail. The connecting rod assembly includes connecting rods and a first elastic member, the connecting rods are movably arranged inside the accommodating cavity and rotationally connected to the cutter body, and the connecting rods are elastically connected to the first elastic member. According to the telescopic cutter provided in the present application, opening and closing operations of the cutter are simplified, thereby improving the operation efficiency of the cutter.

### CROSS-REFERENCE TO RELATED APPLICATIONS

The application claims priority of Chinese patent application 2024113067484, filed on 09/18/2024, which is incorporated herein by reference in its entireties.

### TECHNICAL FIELD

The present disclosure relates to the technical field of cutters, in particular to a telescopic cutter.

### BACKGROUND

Existing handheld cutters mainly have sheath-type, rotary folding-type and rail push-pull-type structures. Although these designs meet daily cutting requirements to a certain extent, there are obvious common defects in opening and closing operations. The sheath-type cutters typically need to be manually pulled out of sheaths and inserted into the sheaths, which prolongs the operation time, and may affect the working efficiency when opening and closing states need to be switched quickly, so that it is difficult for these cutters to adapt to various use scenes and requirements. Although the rotary folding-type cutters provide a manner for achieving opening and closing through rotation, operators are required to have certain operation skills, the cutters can only be opened and closed after components are rotated in place, the speed is relatively low, and thus the cutters are not suitable for situations requiring quick responses. The rail push-pull-type cutters provide a manner for achieving opening and closing through manual push and pull. However, a long time is needed for the process of manually pushing or pulling a cutter body to extend or retract, which cannot meet the requirement for quick opening and closing of the cutter.

The opening and closing operation efficiency of the above three cutters is low, which increases the time cost for using the cutters, and the existing cutters cannot meet the high-efficiency use requirement in the use situations needing frequent and quick switching of the opening and closing states of the cutters.

### SUMMARY

One purpose of the present disclosure is to provide a telescopic cutter, so as to solve the problem of low opening and closing operation efficiency of existing cutters.

A telescopic cutter, including:

a cutter holder provided with an accommodating cavity with an opening at one end, where a sliding rail is arranged inside the accommodating cavity, the sliding rail has a central travel position, and the central travel position divides the sliding rail into a first sliding rail and a second sliding rail connected to each other;

a cutter body movably arranged on the sliding rail, where the cutter body has an extended state in which the cutter body extends out of the opening and a retracted state in which the cutter body retracts back into the accommodating cavity; and

a connecting rod assembly including connecting rods and a first elastic member, where the connecting rods are movably arranged inside the accommodating cavity and rotationally connected to the cutter body, and the connecting rods are elastically connected to the first elastic member; and

under the action of an external force, the cutter body slides along the sliding rail, before the cutter body crosses the central travel position, the first elastic member is compressed to store an elastic force, and after the cutter body crosses the central travel position, the first elastic member releases the elastic force to push the cutter body to slide to be in the extended state or the retracted state.

Optionally, the cutter body and the sliding rail are both arc-shaped; and a guide groove is provided on one side of the cutter holder, the guide groove is in communication with the opening, a protrusion is provided on one side of the cutter body, and the protrusion passes through the guide groove and is exposed on an outer side of the cutter holder.

Optionally, a plurality of connecting rods are provided, at least two of the connecting rods are connected to the first elastic member, the plurality of connecting rods are sequentially rotationally connected through connecting rod shafts to form a multi-connecting-rod structure, and two ends of the multi-connecting-rod structure are respectively rotationally connected to the cutter body and the cutter holder.

Optionally, the first elastic member is a torsion spring, the torsion spring comprises a plurality of spiral portions, and each of the spiral portions is sleeved on one connecting rod shaft, thereby elastically connecting the torsion spring to the plurality of connecting rods.

Optionally, an anti-rotation tooth protrudes from one side of each of the connecting rods, the anti-rotation tooth is in a sleeve shape, and the spiral portion of the torsion spring is sleeved on the periphery of the anti-rotation tooth.

Optionally, further comprising: a limiting assembly arranged inside the accommodating cavity; and a control assembly comprising a button and a second elastic member, wherein one end of the button is rotationally connected to the cutter holder, the other end of the button is in driving connection with the limiting assembly, and two ends of the second elastic member elastically abut against the button and the cutter holder.

Optionally, the limiting assembly comprises a limiting block and a guide column, a limiting hole is provided in the limiting block, the guide column passes through the limiting hole, and two ends of the guide column are connected to the cutter holder.

Optionally, surfaces of the limiting block and the button abutting against each other are inclined surfaces; and/or a clearance groove is provided on a cavity wall of the accommodating cavity, and the limiting block is in clearance fit with a groove wall of the clearance groove; and the button is pressed to push the limiting block to move into the clearance groove in an axial direction of the guide column.

Optionally, an inner wall of the sliding rail is provided with a lubricating coating layer, and the lubricating coating layer is a Teflon coating.

Optionally, the bearings are mounted at one end of the cutter body away from the opening and are movably arranged inside the sliding rail, so that the cutter body is movably connected to the sliding rail.

It can be seen from the above technical solution that the embodiment of the present disclosure at least has the following advantages and positive effects:

the telescopic cutter in the embodiment of the present disclosure includes the cutter holder, the cutter body, and the connecting rod assembly. The cutter holder is provided with the accommodating cavity with the opening at one end, the sliding rail is arranged inside the accommodating cavity, and the sliding rail has the central travel position. The cutter body is movably arranged on the sliding rail. The connecting rod assembly includes the connecting rods and the first elastic member, the connecting rods are movably arranged inside the accommodating cavity and rotationally connected to the cutter body, and the connecting rods are elastically connected to the first elastic member; and under the action of the external force, the cutter body slides along the sliding rail, before the cutter body crosses the central travel position, the first elastic member is compressed to store the elastic force, and after the cutter body crosses the central travel position, the first elastic member releases the elastic force to push the cutter body to slide to be in the extended state or the retracted state. According to the telescopic cutter provided in the present application, opening and closing operations of the cutter are simplified, and the cutter body extends and retracts quickly through simple pushing and pressing, thereby improving the operation efficiency of the cutter.

### BRIEF DESCRIPTION OF THE DRAWINGS

In order to explain embodiments of the present disclosure or technical solutions in the prior art more clearly, drawings needed in descriptions of the embodiments or the prior art will be briefly introduced below. Obviously, the accompanying drawings in the following descriptions are only some embodiments of the present disclosure, and for a person of ordinary skill in the art, other drawings can be obtained according to structures shown in these accompanying drawings without involving any inventive effort.

FIG. 1 is a structural schematic diagram of a telescopic cutter in the present disclosure;

FIG. 2 is an exploded structural schematic diagram of the telescopic cutter as shown in FIG. 1;

FIG. 3 is a schematic diagram of an internal structure of the telescopic cutter with a cutter body completely retracted in the present disclosure;

FIG. 4 is a schematic diagram of an internal structure of the telescopic cutter with part of the cutter body extended in the present disclosure;

FIG. 5 is a schematic diagram of an internal structure of the telescopic cutter with the cutter body completely extended in the present disclosure;

FIG. 6 is a state schematic diagram of the telescopic cutter as shown in FIG. 5 at a second viewing angle;

FIG. 7 is an enlarged structural schematic diagram of area A of the telescopic cutter as shown in FIG. 6; and

FIG. 8 is a structural schematic diagram of connecting rods of the telescopic cutter in the present disclosure.

The description of reference numerals is as follows:

10. telescopic cutter;

100. cutter holder;

200. cutter body;

300. connecting rod assembly;

400. limiting assembly;

500. control assembly;

600. bearing;

700. inclined surface;

110. accommodating cavity;

111. opening;

112. clearance groove;

120. sliding rail;

121. central travel position;

130. guide groove;

140. portable hole;

210. protrusion;

310. connecting rod;

311. limiting portion;

320. first elastic member;

321. spiral portion;

330. connecting rod shaft;

410. limiting block;

411. limiting hole;

420. guide column;

510. button; and

520. second elastic member.

### DETAILED DESCRIPTION OF EMBODIMENTS

Typical embodiments that show the characteristics and advantages of the present disclosure will be described in detail in the following description. It should be understood that the present disclosure can have various changes in different embodiments, which do not depart from the scope of the present disclosure. In addition, the description and drawings herein are essentially for the purpose of describing, instead of limiting the present disclosure.

Besides, the terms “first” and “second” are only for the purpose of describing, and cannot be understood as indicating or implying the relative importance or implicitly indicating the number of technical features indicated. Thus, the features defined as “first” and “second” may explicitly or implicitly include one or more such features. In the description of the present application, unless otherwise explicitly specified, “a plurality of” means two or more.

In the description of the present application, it should also be noted that unless otherwise specified and limited, the terms “arrangement”, “connecting” and “connection” should be understood in a broad sense, for example, they may be fixed connection, and may also be detachable connection or integrated connection; they may be mechanical connection, and may also be electrical connection; and they may be direct connection, and may also be indirect connection by means of intermediate media or communication of the interiors of two elements. The specific meanings of the above terms in the present application may be understood by those of ordinary skill in the art according to specific circumstances.

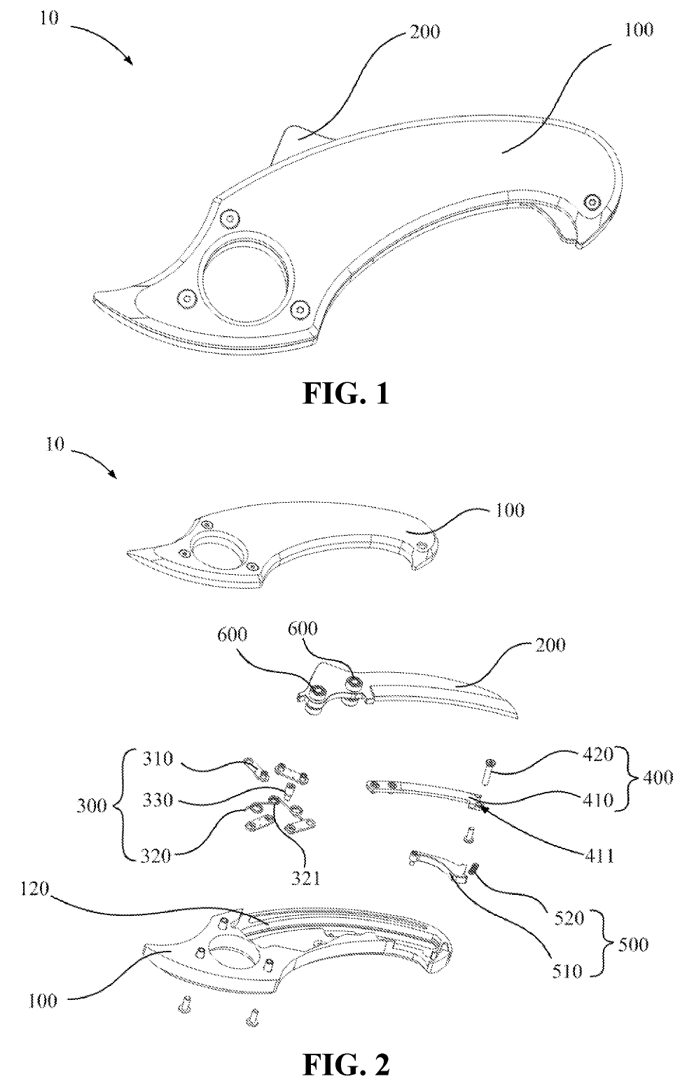

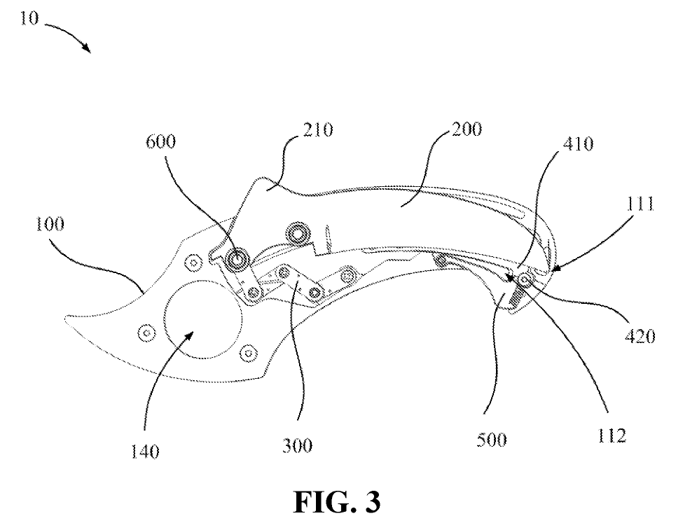

Reference is first made to FIG. 1 to FIG. 7. FIG. 5 shows an extended state in which a cutter body 200 of a telescopic cutter 10 completely extends, and FIG. 3 shows a retracted state in which the cutter body 200 of the telescopic cutter 200 completely retracts.

The present disclosure provides the telescopic cutter 10, which is convenient to carry, is applicable to cutting tasks during outdoor activities, and is also applicable to playing for relaxing at leisure. The telescopic cutter 10 includes: a cutter holder 100, a cutter body 200, a connecting rod assembly 300, a limiting assembly 400, and a control assembly 500. The cutter holder 100 is provided with an accommodating cavity 110 with an opening 111 at one end, and a sliding rail 120 is arranged inside the accommodating cavity 110. The cutter body 200 is movably arranged on the sliding rail 120, and the cutter body 200 has an extended state in which the cutter body extends out of the opening 111 and a retracted state in which the cutter body retracts back into the accommodating cavity 110. The connecting rod assembly 300 includes connecting rods 310 and a first elastic member 320, the connecting rods 310 are movably arranged inside the accommodating cavity 110 and rotationally connected to the cutter body 200, and the connecting rods 310 are elastically connected to the first elastic member 320. The limiting assembly 400 is arranged inside the accommodating cavity 110. The control assembly 500 includes a button 510 and a second elastic member 520, one end of the button 510 is rotationally connected to the cutter holder 100, the other end of the button is in driving connection with the limiting assembly 400, and two ends of the second elastic member 520 elastically abut against the button 510 and the cutter holder 100.

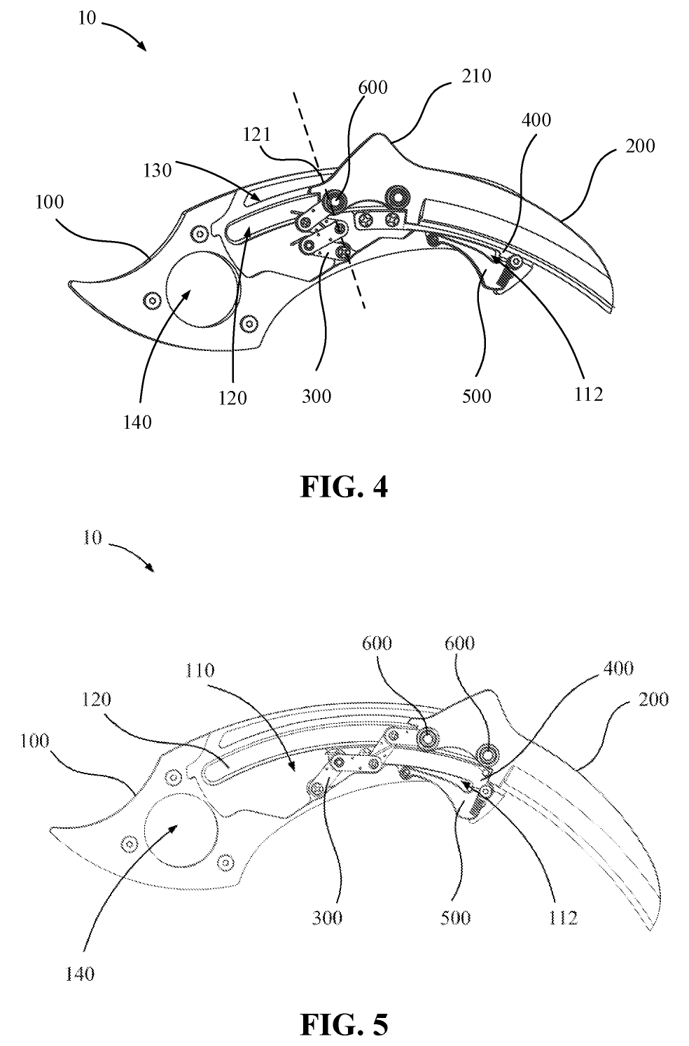

Specifically, reference is made to FIG. 4, and the sliding rail 120 has a central travel position 121. Under the action of an external force, the cutter body slides along the sliding rail 120, before the cutter body 200 crosses the central travel position 121, the first elastic member 320 is compressed to store an elastic force, and after the cutter body 200 crosses the central travel position 121, the first elastic member 320 releases the elastic force to push the cutter body 200 to slide to be in the extended state or the retracted state.

The extending process of the cutter body 200 is as follows: an initial state is the retracted state as shown in FIG. 3, the cutter body 200 is pushed to slide along the sliding rail 120 to move towards the opening 111, then the first elastic member 320 is compressed to store the elastic force, as shown in FIG. 4, the cutter body 200 is continuously pushed to move along the sliding rail 120 to cross the central travel position 121, and then the first elastic member 320 releases the elastic force to push the cutter body 200 to slide continuously to be in the extended state as shown in FIG. 5. The state change process of the telescopic cutter 10 proceeds from FIG. 3 to FIG. 4 to FIG. 5.

The retracting process of the cutter body 200 is as follows: an initial state is the extended state as shown in FIG. 5, the cutter body 200 is pushed to move along the sliding rail to move in a direction away from the opening 111, then the first elastic member 320 is compressed to store the elastic force, as shown in FIG. 4, the cutter body 200 is continuously pushed to move along the sliding rail 120 to cross the central travel position 121 in an opposite direction, and then the first elastic member 320 releases the elastic force to push the cutter body 200 to slide continuously to be in the retracted state as shown in FIG. 3. The state change process of the telescopic cutter 10 proceeds from FIG. 5 to FIG. 4 to FIG. 3.

It can be understood that in this embodiment, when the telescopic cutter 10 is in the retracted state and the extended state, the first elastic member 320 is in an elastically abutting state, that is, the connecting rod assembly 300 has a limiting effect on the cutter body 200 in the retracted state and the extended state, thereby preventing the cutter body 200 from moving; and then the limiting assembly 400 and the control assembly 500 may not be arranged, and the cutter body 200 is limited through the first elastic member 320. Of course, a manufacturer may also freely adjust the state of the first elastic member 320 in the extended state and the retracted state according to requirements.

It should be noted that crossing the central travel position 121 in the present application refers to a joint between the connecting rod assembly 300 and the cutter body 200 crossing the central travel position 121. The central travel position 121 is not defined as the center position of the sliding rail 120, and the central travel position 121 is determined by the relative positions of the connecting rod assembly 300 and the cutter body 200.

In this embodiment, an inner wall of the sliding rail 120 is provided with a lubricating coating layer, and the lubricating coating layer is a Teflon coating, which has the advantages of resistance to chemical corrosion, fire prevention, flame retardancy, and long service life. It can be understood that in other embodiments, the Teflon coating may also be replaced with other coatings or adhesive layers.

In this embodiment, the design of the cutter holder 100 not only provides a space for accommodating the cutter body 200 and mounting various parts, but also facilitates holding and operation by a user, thereby ensuring the operation stability and safety. The cutter holder 100 may be made of a material such as an aluminum alloy or stainless steel, and thus has the characteristics of corrosion resistance and portability. The cutter holder 100 is composed of two housings completely identical in shape and size, and the two housings may be detachably connected through screws, pins or snap fasteners, thereby facilitating mounting, dismounting, replacement and maintenance of parts of the telescopic cutter 10. A portable hole 140 is provided at one end of the cutter holder 100 away from the opening 111, and the portable hole 140 not only provides an additional holding point to achieve more stable holding, but also provides the convenience in suspending or fixing the cutter, so that the user may easily hang the cutter on a hook or tie same on a belt.

The cutter body 200 may be slidably connected to the sliding rail 120 through bearings 600, or sliding blocks and sliding grooves are respectively provided on the cutter body 200 and the sliding rail 120, and through the cooperation of the sliding blocks and the sliding grooves, the cutter body 200 is slidably connected to the sliding rail 120. The sliding rail 120 not only provides sliding guide for the cutter body 200, but also limits sliding of the cutter body 200, thereby ensuring that the cutter body 200 moves along a preset movement track in a telescopic process, so as to improve the extending stability.

The cutter body 200 may be made of stainless steel, alloy steel or a ceramic material, and thus has the good hardness and wear resistance. The cutter body 200 is provided with a push member, and the user pushes the push member to drive the cutter body 200 to move, so that the cutter body 200 is more effort-saving and convenient to move. The size of the accommodating cavity 110 is greater than that of the cutter body 200, and when the cutter body 200 is in the retracted state, the cutter body 200 is completely located inside the accommodating cavity 110, thereby improving the operation safety.

Through the design in which the cutter body 200 is rotationally connected to the cutter holder 100 through the connecting rods 310, the cutter body 200 is more stable when moving along the sliding rail 120 relative to the cutter holder 100.

Clamping structures such as clamping grooves, snap fasteners or clamping blocks may be arranged at the joint between the limiting assembly 400 and the cutter body 200, and the cutter body 200 is clamped with the limiting assembly 400 through these clamping structures. The limiting assembly 400 is arranged on a movement path of the cutter body 200 and is arranged at a position of the accommodating cavity 110 close to the opening 111, so that when the cutter body 200 is clamped with the limiting assembly 400, the cutter body 200 is in the maximum extending length, which provides the maximum cutting length, and improves the cutting working efficiency.

The button 510 is exposed on an outer side of the cutter holder 100, so that it is easy to touch and operate by the user, and the user may quickly start extending and retracting of the cutter. The second elastic member 520 is a spring, the button 510 is provided with a spring slot (not shown), one end of the spring is embedded into the spring slot, the other end of the spring abuts against a limiting block 410, and the spring slot has the effect of limiting the spring, thereby preventing the lateral displacement of the spring during the compression process, and improving the stability of the spring during deformation. In addition to a pressing type structure in which the button 510 cooperates with the elastic member in the present application, to achieve the design in which the limiting assembly 400 is separated from the cutter body 200, the limiting assembly 400 and the cutter body 200 may also be unlocked through a sliding structure, a rolling structure, a rotating structure and the like.

During extending, the cutter body 200 is pushed to move along the sliding rail 120 until the cutter body 200 extends out of the opening 111 of the accommodating cavity 110, then the cutter body 200 is clamped with the limiting assembly 400 so that the cutter body 200 is in the extended state, and the first elastic member 320 stores the elastic force before releases the elastic force during this process. During retracting, the button 510 of the control assembly 500 is pressed to compress the second elastic member 520 to drive the limiting assembly 400 to be separated from the cutter body 200, and along with the separation of the limiting assembly 400, the user can reversely pull the cutter body 200 and drive the connecting rods 310 to drive the cutter body 200 to retract into the accommodating cavity 110. According to the telescopic cutter 10 provided in the present application, opening and closing operations of the cutter are simplified, and the cutter body 200 extends and retracts quickly through simple pushing and pressing, thereby improving the operation efficiency of the cutter.

Reference is made to FIGS. 3 to 5. The cutter body 200 and the sliding rail 120 are both arc-shaped; and a guide groove 130 is provided on one side of the cutter holder 100, the guide groove 130 is in communication with the opening 111, a protrusion 210 is provided on one side of the cutter body 200, the protrusion 210 passes through the guide groove 130 and is exposed on an outer side of the cutter holder 100, and the protrusion 210 is pushed to enable the cutter body 200 to move along the sliding rail 120 and extend out of the opening 111.

In this embodiment, the cutter body 200 and the sliding rail 120 are designed to have the same radian, thereby ensuring the consistent contact and stable movement with the sliding rail 120 when the cutter body 200 moves along the sliding rail 120, and improving the telescopic performance and service life of the cutter.

An extending direction of the guide groove 130 is the same as a movement direction of the cutter body 200, so that the protrusion 210 extending out of the guide groove 130 is conveniently pushed to drive the cutter body 200 to move along the sliding rail 120. The size of the guide groove 130 should be slightly greater than that of the protrusion 210, thereby reserving a sufficient space to ensure that the protrusion 210 may slide smoothly, and avoiding an excessive gap which results in shaking of the protrusion 210. The protrusion 210 is located on one side of the cutter body 200 away from the opening 111 in the retracted state, so that the user pushes the cutter body 200 in a more convenient and effort-saving manner.

Reference is made to FIGS. 1 to 5. The telescopic cutter 10 is in the shape of an eagle claw. In this embodiment, the eagle-claw-shaped design provides a shape more suitable to be naturally held by hand, increases the comfort level and stability during holding, and is more effort-saving. Compared with linear and cylindrical handle designs, the eagle-claw-shaped design increases the contact area between the cutter and the hand, thereby providing better stability during the operation process, and reducing the probability of sliding or displacement of the cutter.

Reference is made to FIGS. 2 to 5. A plurality of connecting rods 310 are provided, at least two of the connecting rods 310 are connected to the first elastic member 320, the plurality of connecting rods 310 are sequentially rotationally connected through connecting rod shafts 330 to form a multi-connecting-rod structure, and two ends of the multi-connecting-rod structure are respectively rotationally connected to the cutter body 200 and the cutter holder 100. In the retracted state, the first elastic member 320 drives the multi-connecting-rod structure to retract, so as to drive the cutter body 200 to retract into the accommodating cavity 110.

In this embodiment, the first elastic member 320 may be a torsion spring or a spring, four connecting rods 310 are provided, and the first elastic member 320 may be elastically connected to each connecting rod 310, so that the elasticity of the first elastic member 320 is more uniformly distributed on each connecting rod 310 and acts on the cutter body 200, overloading or damage that may be caused by the fact that the power is concentrated on the single connecting rod 310 is avoided, and the stability and reliability of the entire connecting rod assembly 300 are enhanced. Some of the connecting rods 310 may also be elastically connected to the first elastic member 320. In other embodiments, three or five connecting rods 310 may be provided.

The multi-connecting-rod structure provides an efficient and stable power transmission means for the telescopic cutter 10. When the user performs the retracting operation, the multi-connecting-rod structure moves synchronously to enable the cutter body 200 to stably and uniformly retract into the accommodating cavity 110. Such design greatly reduces the non-uniform load and stress concentration that may be caused by the single connecting rod 310, thereby reducing the wear and failure rate of the cutter.

Reference is made to FIGS. 2 to 5. The first elastic member 320 is a torsion spring, the torsion spring includes a plurality of spiral portions 321, and each spiral portion 321 is sleeved on one connecting rod shaft 330, thereby elastically connecting the torsion spring to the plurality of connecting rods 310.

In this embodiment, the torsion spring can provide high-elasticity output in a small space, and is very suitable for space-limited applications. When it is used in the multi-connecting-rod structure, the space is saved, and necessary power is provided for the connecting rods 310. The torsion spring may be designed in different shapes, sizes and wire diameters so as to adapt to different application requirements. For example, in the present application, the torsion spring is designed to have a plurality of spiral portions 321, each spiral portion 321 is formed by spirally winding an elastic metal, the spiral portion 321 is sleeved on the connecting rod shaft 330, and the connecting rod shaft 330 plays a role in limiting the torsion spring, thereby improving the stability of the torsion spring during the deformation process. An anti-rotation tooth 311 protrudes from one side of each connecting rod 310, the anti-rotation tooth 311 is in a sleeve shape, the anti-rotation tooth 311 is sleeved on the periphery of the connecting rod shaft 330, and then the spiral portion 321 of the torsion spring is sleeved on the periphery of the anti-rotation tooth 311. When two connecting rods 310 rotationally connected to each other rotate to a certain angle, the anti-rotation teeth 311 on the two connecting rods 310 abut against each other and mutually limit each other's rotation, thereby playing a role in limiting the rotation of the connecting rods 310, preventing the problem that the cutter body 200 is jammed or the cutter body 200 is separated from the cutter holder 100 due to the excessively large rotation angle of the connecting rods 310, and improving the reliability of the cutter during use. The two spiral portions 321 are connected through the linear elastic metal. By arranging the plurality of spiral portions 321, when each connecting rod 310 rotates, it undergoes the elastic action of the first elastic member 320, so that when the cutter body 200 is in the retracted state or the extended state, the plurality of connecting rods 310 undergo the elastic action of the first elastic member 320, thereby improving the stability of the multi-connecting-rod structure during rotation.

Reference is made to FIGS. 2 to 5. The limiting assembly 400 includes the limiting block 410 and a guide column 420, a limiting hole 411 is provided in the limiting block 410, the guide column 420 passes through the limiting hole 411, and two ends of the guide column 420 are connected to the cutter holder 100. In the extended state, the limiting block 410 is clamped with the cutter body 200. The button 510 is pressed, the button 510 abuts against the limiting block 410 and pushes the limiting block 410 to move in an axial direction of the guide column 420 to separate the limiting block 410 from the cutter body 200, and the cutter body 200 retracts into the accommodating cavity 110.

In this embodiment, the limiting block 410 and the guide column 420 may be made of a high-strength metal or engineering plastic, thereby providing the required strength and durability. The shape of the limiting block 410 may be designed to be matched with that of a contact surface of the cutter body 200, thereby ensuring that when the cutter body 200 extends, there is a maximum contact area between the limiting block 410 and the cutter body 200, improving the clamping stability between the limiting block 410 and the cutter body 200. The limiting block 410 may adopt an internal reinforcing rib design, thereby improving the structural stiffness and durability thereof, and preventing deformation or damage during repeated use. The guide column 420 may be connected to the cutter holder 100 in a threaded connection or snap-fit manner, thereby ensuring the stability and reliability of the cutter during the use process. The threaded connection allows quick mounting and dismounting and maintenance, and the snap-fit connection provides the convenience in quick connection without a tool.

The limiting hole 411 is provided in the limiting block 410, so that the guide column 420 can be accurately positioned on the limiting block 410, which ensures that the cutter body 200 moves along the preset track when extending and retracting. The edge of the limiting hole 411 may be designed to be chamfered or rounded, thereby reducing the wear of the guide column 420. Meanwhile, the cooperative use of the limiting hole 411 and the guide column 420 provides a stable guide mechanism, which reduces the shaking or deviation of the cutter during the use process, and improves the use accuracy.

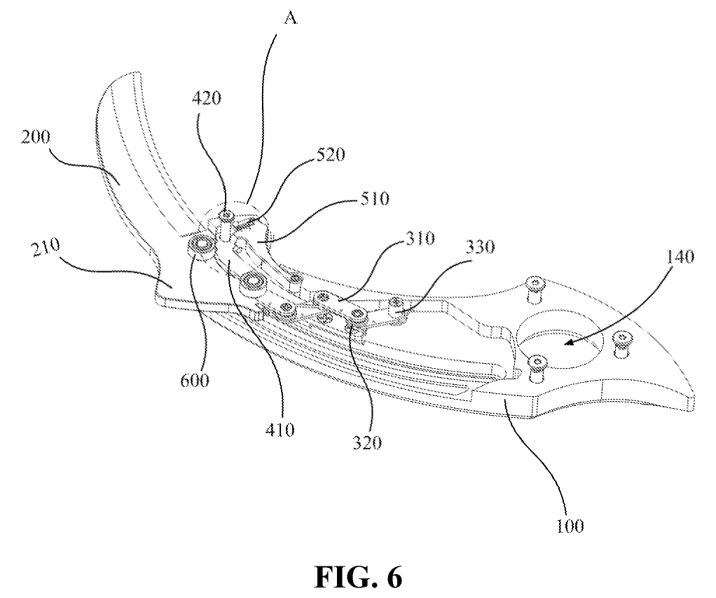

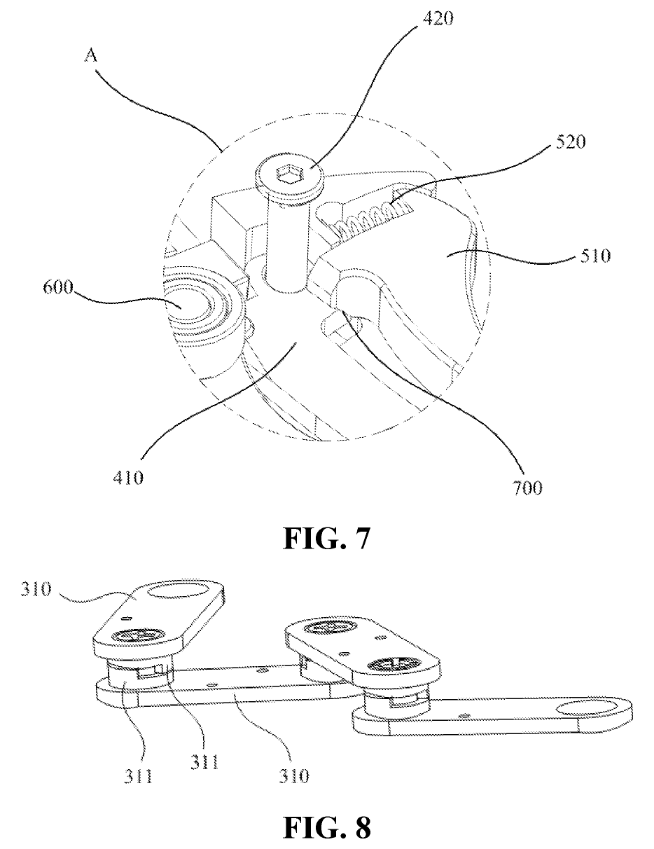

Reference is made to FIGS. 6 to 7. Surfaces of the limiting block 410 and the button 510 abutting against each other are inclined surfaces 700. In this embodiment, during retracting, the button 510 is pressed, due to the design of the inclined surfaces 700, an angle is formed between a movement direction of the button 510 and a separation direction of the limiting block 410, and part of the power of the button 510 is converted into a force for pushing the limiting block 410. Thus, by arranging the surfaces of the limiting block 410 and the button 510 abutting against each other as the inclined surfaces 700, the user can easily retract the cutter with a small force, and it is more effort-saving and efficient to retract. Meanwhile, the inclined surfaces 700 also help to smoothen the movement of the button 510 and reduce the frictional force between the limiting block 410 and the inclined surface 700, making the retracting process smoother.

Reference is made to FIG. 3. A clearance groove 112 is provided on a cavity wall of the accommodating cavity 110, and the limiting block 410 is in clearance fit with a groove wall of the clearance groove 112; and the button 510 is pressed to push the limiting block 410 to move into the clearance groove 112 in an axial direction of the guide column 420.

In this embodiment, there is a certain gap between the clearance groove 112 and the limiting block 410, so that the limiting block 410 can stably slide in the clearance groove 112, meanwhile, the friction and wear between the limiting block 410 and the clearance groove 112 are avoided, and the service life of the cutter is prolonged. When the button 510 is pressed to push the limiting block 410 to move in the axial direction of the guide column 420, the clearance groove 112 plays a role in guiding the movement of the limiting block 410, thereby ensuring that the limiting block 410 can smoothly move to the required position, and preventing the limiting block 410 from colliding with or interfering with other components during the movement process. In addition, the introduction of the clearance groove 112 also simplifies the maintenance and assembly process of the cutter. The clearance groove 112 provides a clearance space for movement of the limiting block 410, so that when the limiting block 410 is maintained or replaced, it is easier to dismount and mount again, and the maintenance time and cost are reduced.

Reference is made to FIGS. 2 to 5. The telescopic cutter 10 further includes bearings 600, and the bearings 600 are mounted at one end of the cutter body 200 away from the opening 111 and are movably arranged inside the sliding rail 120, so that the cutter body 200 is movably connected to the sliding rail 120.

In this embodiment, the bearings 600 are ball bearings 600, and each ball bearing 600 is composed of an inner ring, an outer ring, and spherical balls arranged between the inner ring and the outer ring. Due to the low friction characteristic of the ball bearings 600, the cutter body 200 can quickly and easily extend and retract, the friction and noise during extending and retracting of the cutter body 200 are reduced, and the response speed and operation smoothness of the cutter are improved. In other embodiments, the bearings 600 can also be replaced with components such as balls, rollers and the like, which can also achieve the effect of quickly and easily extending and retracting the cutter body 200.

Reference is made to FIGS. 2 to 5. Four bearings 600 are provided, the four bearings 600 are movably arranged in the sliding rail 120, and one of the bearings 600 is rotationally connected to the connecting rod 310.

In this embodiment, by arranging the four bearings 600 and respectively symmetrically arranging the four bearings 600 on two sides of the cutter body 200, the stability and support of the cutter body 200 in the sliding rail 120 are enhanced, and more uniform load distribution is achieved. Such structural design helps to reduce the inclination or deviation of the cutter body 200 that may be caused by the non-uniform load, thereby ensuring the stable movement of the cutter body 200 in the telescopic process, and improving the cutting accuracy and the overall performance of the cutter.

One of the bearings 600 is rotationally connected to the connecting rod 310, providing higher flexibility for the connecting rod assembly 300. Such connection means allows free rotation of the connecting rods 310 in the telescopic process, thereby reducing the friction and wear caused by the contact between the connecting rods 310 and the cutter body 200 or the sliding rail 120. The service life of the cutter is prolonged, the cutter is smoother to operate, and the required maintenance work is reduced. In conjunction with the implementation manner of the connecting rod assembly 300, when the bearings 600 are arranged on the cutter body 200, one spiral portion 321 of the torsion spring can be sleeved on the bearing 600, so as to rotationally connect the cutter body 200 to the connecting rod 310.

Although the present disclosure is described with reference to several typical embodiments, it should be understood that the used terms are illustrative and exemplary terms instead of restrictive terms. Since the present disclosure can be specifically implemented in various forms without departing from the spirit or essence of the disclosure, it should be understood that the above embodiments are not limited to any foregoing detail and should be broadly explained within the spirit and scope defined by the appended claims. Therefore, all changes and modifications falling within the claims or the equivalent scope thereof should be covered by the appended claims.

1. A telescopic cutter, comprising:
a cutter holder provided with an accommodating cavity with an opening at one end, wherein a sliding rail is arranged inside the accommodating cavity, and the sliding rail has a central travel position;
a cutter body movably arranged on the sliding rail, wherein the cutter body has an extended state in which the cutter body extends out of the opening and a retracted state in which the cutter body retracts back into the accommodating cavity; and
a connecting rod assembly comprising connecting rods and a first elastic member, wherein the connecting rods are movably arranged inside the accommodating cavity and rotationally connected to the cutter body, and the connecting rods are elastically connected to the first elastic member; and
under the action of an external force, the cutter body slides along the sliding rail, before the cutter body crosses the central travel position, the first elastic member is compressed to store an elastic force, and after the cutter body crosses the central travel position, the first elastic member releases the elastic force to push the cutter body to slide to be in the extended state or the retracted state.

2. The telescopic cutter according to claim 1, wherein the cutter body and the sliding rail are both arc-shaped; and a guide groove is provided on one side of the cutter holder, the guide groove is in communication with the opening, a protrusion is provided on one side of the cutter body, and the protrusion passes through the guide groove and is exposed on an outer side of the cutter holder.

3. The telescopic cutter according to claim 1, wherein a plurality of connecting rods are provided, at least two of the connecting rods are connected to the first elastic member, the plurality of connecting rods are sequentially rotationally connected through connecting rod shafts to form a multi-connecting-rod structure, and two ends of the multi-connecting-rod structure are respectively rotationally connected to the cutter body and the cutter holder.

4. The telescopic cutter according to claim 3, wherein the first elastic member is a torsion spring, the torsion spring comprises a plurality of spiral portions, and each of the spiral portions is sleeved on one connecting rod shaft, thereby elastically connecting the torsion spring to the plurality of connecting rods.

5. The telescopic cutter according to claim 4, wherein an anti-rotation tooth protrudes from one side of each of the connecting rods, the anti-rotation tooth is in a sleeve shape, and the spiral portion of the torsion spring is sleeved on the periphery of the anti-rotation tooth.

6. The telescopic cutter according to claim 1, further comprising:
a limiting assembly arranged inside the accommodating cavity; and
a control assembly comprising a button and a second elastic member, wherein one end of the button is rotationally connected to the cutter holder, the other end of the button is in driving connection with the limiting assembly, and two ends of the second elastic member elastically abut against the button and the cutter holder.

7. The telescopic cutter according to claim 6, wherein the limiting assembly comprises a limiting block and a guide column, a limiting hole is provided in the limiting block, the guide column passes through the limiting hole, and two ends of the guide column are connected to the cutter holder.

8. The telescopic cutter according to claim 7, wherein surfaces of the limiting block and the button abutting against each other are inclined surfaces; and/or
a clearance groove is provided on a cavity wall of the accommodating cavity, and the limiting block is in clearance fit with a groove wall of the clearance groove; and the button is pressed to push the limiting block to move into the clearance groove in an axial direction of the guide column.

9. The telescopic cutter according to claim 1, wherein an inner wall of the sliding rail is provided with a lubricating coating layer, and the lubricating coating layer is a Teflon coating.

10. The telescopic cutter according to claim 1, further comprising bearings, wherein the bearings are mounted at one end of the cutter body away from the opening and are movably arranged inside the sliding rail, so that the cutter body is movably connected to the sliding rail.
